(19) United States
(12) Patent Application Publication
(10) Pub. No.: US 2024/0375537 A1
(43) Pub. Date: Nov. 14, 2024

(54) CONTROLLING AND SCHEDULING OF CHARGING OF ELECTRICAL VEHICLES AND RELATED SYSTEMS AND METHODS

(71) Applicant: Hitachi Energy Ltd, Zürich (CH)

(72) Inventors: Donato ZARRILLI, Hamburg (DE); Pablo ALMALECK, Genova (IT)

(21) Appl. No.: 18/683,120

(22) PCT Filed: Aug. 13, 2021
(86) PCT No.: PCT/EP2021/072606

§ 371 Date: Feb. 12, 2024

(51) Int. Cl. B60L 53/62; B60L 53/63; B60L 53/67; B60L 58/12

(52) U.S. Cl. CPC B60L 53/62; B60L 53/63; B60L 58/12; B60L 53/67; B60L 2240/62

(57) ABSTRACT

A method is disclosed for controlling the charging of at least one electric vehicle, in particular two or more electric vehicles, via at least one charger, in particular two or more chargers. In an embodiment, the method comprises determining a charging profile for charging at least one electric vehicle via at least one charger based at least on a characteristic of a battery of the at least one electric vehicle, information on available power, and an availability of the at least one electric vehicle, and providing an output to control charging by the respective charger in accordance with the determined charging profile.

### FIELD

The present disclosure relates to methods, apparatus, and computer programs for controlling and scheduling of charging of electric vehicles.

### BACKGROUND

The drive towards clean energies has fostered growth in the adoption of distributed energy resources (DERs), in the application of demand side management and in the electrification of urban transportation. This growth has been driven, at least in in part, by challenging environmental and economic targets set out by government policies worldwide. Technical problems are found in the integration and use of small-size DERs such as renewables, on-site generators, storage devices, controllable loads, and electric vehicles (EVs).

Many transportation companies are replacing their existing vehicles, typically running using diesel engines, with cleaner electric vehicles. These electric vehicles have the potential to exploit more environmentally friendly energy sources. In this context, energy management systems are required to address modern power system challenges caused by integrating and aggregating DERs. In particular, large-scale penetration of such EVs without proper management systems may lead to technical problems such as uneven and unpredictable aggregated demand profiles with high power absorption peaks. This in turn may lead to technical problems such as potential bottlenecks in supply capacity and expose electric vehicle fleet operators to equipment dimensioning issues.

Technical problems exist in managing the charging a fleet of electric vehicles at a shared charging location such as a depot. For example there may be challenges in managing electric power supply usage.

An aim of some embodiments is to address or at least mitigate one or more of the problems discussed previously.

### SUMMARY

According to an aspect, there is provided a method for controlling the charging of at least one electric vehicle, in particular two or more electric vehicles, via at least one charger, in particular two or more chargers, according to claim 1.

The method comprises: determining a charging profile for charging at least one electric vehicle via at least one charger based at least on a characteristic of a battery of the at least one electric vehicle, information on available power, and an availability of the at least one electric vehicle; and providing an output to control charging by the respective charger in accordance with the determined charging profile.

Further embodiments and aspects of said method may further address one or more of above described problems.

According to a further embodiment the method may be computer implemented and/or executed by at least one integrated circuit. The method may be performed by an apparatus such as an industrial controller, a computing device, or a controller of an Energy Management System (EMS).

According to a further embodiment the availability of the at least one electric vehicle may be based at least on one of an operation schedule, location information of the at least one electric vehicle and real time location information of the at least one electric vehicle.

The operation schedule may provide information as to when one or more electric vehicles are to arrive and/or information as to when one or more electric vehicles are to leave a charging location where one or more chargers are provided.

The determining of the charging profile for charging the at least one electric vehicle may be further based on a requirement of preconditioning of at least one of the electric vehicles.

In a further embodiment, the method comprises providing an output to control the preconditioning of the at least one electric vehicle.

The information on available power may comprise information about power suppliable by one or more of: a power grid; and/or one or more local power sources.

A local power source may be a power source provided within a same microgrid as at least one of the chargers.

In a further embodiment, the determining of the charging profile for charging the at least one electric vehicle comprises an optimization process.

The optimization process may comprise a first objective to reduce variations in charging operations and/or preconditioning operations provided by the charging profile.

This may be to avoid or reduce interruptions in the charging process of a battery and/or to avoid current peaks. This may reduce a stress on the battery which stress may reduce the effective lifetime of a battery.

The optimization process may comprise a minimum charging level constraint relating to a minimum charging level of the respective battery of the at least one electric vehicle.

The optimization process may comprise a maximum charging level constraint relating to a maximum charging level of the respective battery of the at least one electric vehicle.

The optimization process may comprise a second objective to maximise a charging level of the respective battery beyond the minimum charging level, in particular up to a predefined charging level.

The optimization process may comprise an available power constraint relating to the information on the available power.

The optimization process may comprise an electric vehicle availability constraint relating to the availability of the at least one electric vehicle.

The optimization process may comprise a battery maximum load constraint relating to a maximum load applicable to the respective battery.

The determining may be further based on a power supply limit associated with one or more of the chargers.

The characteristic of the battery may comprise a charging state of the battery.

The characteristic of the battery may comprise at least one of: one or more charging state limitations; and one or more charging rate limitations.

The determining of the charging profile for charging the at least one electric vehicle may be further based on information relating to a current time period and information from one or more future time periods.

The determining of the charging profile for charging the at least one electric vehicle may be repeated at a subsequent time to update the charging profile.

The output to control charging may control one or more of when the at least one electric vehicle is charged and a rate at which the at least one electric vehicle is charged.

According to another aspect, there is provided an apparatus configured to control the charging of at least one electric vehicle, in particular two or more electric vehicles via at least one charger, in particular two or more chargers, the apparatus comprising at least one integrated circuit configured to cause the apparatus to: determine a charging profile for charging at least one electric vehicle via at least one charger based at least on a characteristic of a respective battery of the at least one electric vehicle, information on available power, and an availability of the at least one electric vehicle; and provide an output to control charging by the respective charger in accordance with the determined charging profile.

The apparatus may address or mitigate one or more of the problems discussed previously.

The availability of the at least one electric vehicle may be based at least on one of an operation schedule, location information of the at least one electric vehicle and real time location information of the at least one electric vehicle.

The operation schedule may provide information as to when one or more electric vehicles are to arrive and/or information as to when one or more electric vehicles are to leave a charging location where one or more chargers are provided.

The at least one integrated circuit may be configured to cause the apparatus to determine the charging profile for charging the at least one electric vehicle further based on a requirement of preconditioning of at least one of the electric vehicles.

The at least one integrated circuit may be configured to cause the apparatus to provide an output to control the preconditioning of the at least one of the electric vehicles.

The information on available power may comprise information about power suppliable by one or more of: a power grid; and/or one or more local power sources.

A local power source may be a power source provided within a same microgrid as at least one of the chargers.

The at least one integrated circuit may be configured to cause the apparatus to determine the charging profile for charging the at least one electric vehicle using an optimization process.

The optimization process may comprise a first objective to reduce variations in charging operations and/or preconditioning operations provided by the charging profile.

This may be to avoid or reduce interruptions in the charging process of a battery and/or to avoid current peaks. This may reduce a stress on the battery which may reduce the effective lifetime of a battery.

The optimization process may comprise a minimum charging level constraint relating to a minimum charging level of the respective battery of the at least one electric vehicle.

The optimization process may comprise a maximum charging level constraint relating to a maximum charging level of the respective battery of the at least one electric vehicle.

The optimization process may comprise a second objective to maximise a charging level of the respective battery beyond the minimum charging level, in particular up to a predefined charging level.

The optimization process may comprise an available power constraint relating to the information on the available power.

The optimization process may comprise an electric vehicle availability constraint relating to the availability of the at least one electric vehicle.

The optimization process may comprise a battery maximum load constraint relating to a maximum load applicable to the respective battery.

The at least one integrated circuit may be configured to cause the apparatus to determine the charging profile further based on a power supply limit associated with one or more of the chargers.

The characteristic of the battery may comprise a charging state of the battery.

The characteristic of the battery may comprise at least one of: one or more charging state limitations; and one or more charging rate limitations.

The at least one integrated circuit may be configured to cause the apparatus to determine the charging profile for charging the at least one electric vehicle further based on information relating to a current time period and information from one or more future time periods.

The at least one integrated circuit may be configured to cause the apparatus to repeat the determining of the charging profile for charging the at least one electric vehicle at a subsequent time to update the charging profile.

The output to control charging may control one or more of when the at least one electric vehicle is charged and a rate at which the at least one electric vehicle is charged.

According to an aspect, there is provided a computer program comprising computer executable instructions which when run on at least one processor cause any one of the above methods to be performed.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### DESCRIPTION OF FIGURES

Some examples will now be described, by way of example only, with reference to the accompanying Figures in which:

FIG. 1 shows a system of some embodiments;

FIG. 2 schematically shows a rolling time horizon used in some embodiments;

FIG. 3 shows an exemplary apparatus according to an embodiment of the invention;

FIG. 4 shows, schematically, an example method of some embodiments; and

FIG. 5 shows, schematically, another example method of some embodiments.

### DETAILED DESCRIPTION

Various example embodiments of the invention will now be described. Some embodiments relate to the controlling of at least one electric vehicle. Some example embodiments comprise methods for controlling the charging of at least one electric vehicle. Some example embodiments comprise an apparatus for controlling the charging of at least one electric vehicle. The apparatus may comprise an integrated circuit and/or may be a device. The device may be a computer device, an industrial controller, or any other suitable device. Some embodiments relate to a system for controlling the charging of at least one electric vehicle.

The charging of the at least one electric vehicle may be via at least one charger.

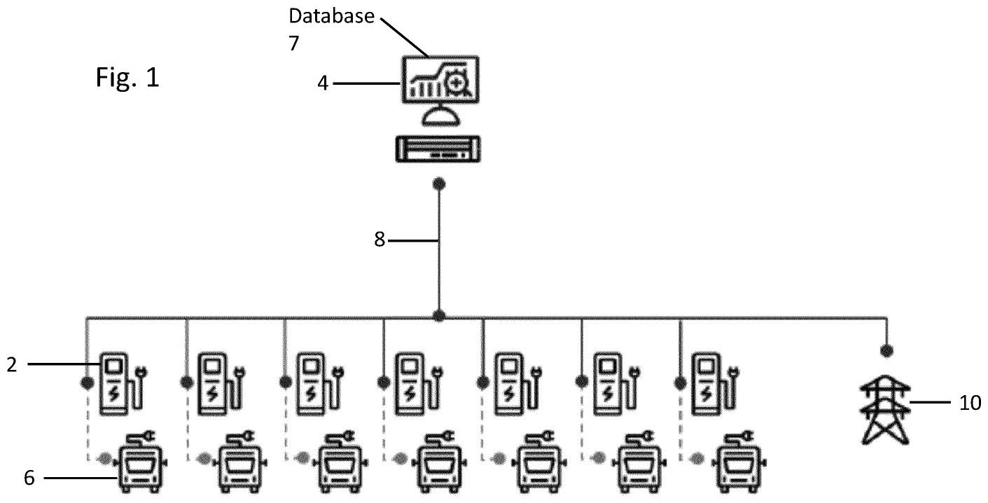

Reference is made to FIG. 1 which shows a system of some embodiments. The system comprises a number of chargers 2. The chargers 2 are connected to the apparatus 4 for controlling the charging.

Some embodiments may be for managing the charging of a set or fleet of electric vehicles (EVs) 6. The EVs 6 to be charged are plugged into a respective charger 2. This charging may be provided by at least one charger 2. In case more than one charger 2 is provided the chargers 2 may be arranged at one or more charging locations.

The set of electric vehicles 6 may be electric buses, delivery vehicles, taxis, utility vehicles, boats, factory vehicles, aerial vehicles, drones, or any other vehicle.

The respective charging location may be a depot, a garage or any other charging location comprising one or more chargers and suitable for the vehicles which are to be charged. In some embodiments there may be more than one charging location, for example, two bus depots.

Some embodiments may be used where a relatively large number of electric vehicles 6 need to be charged at a charging location which has a relatively large number of chargers 2. The number of chargers may be for example more than 10, 50, or 100 chargers. These number of chargers are by way of example only and other embodiments may use any other suitable number of chargers.

In the following, the example of an electric vehicle fleet comprising one or more vehicles 6 is described. The vehicles are charged at a charging location.

As mentioned the electric vehicle fleet may comprise a fleet of buses or any other fleet of electric vehicles. The charging location may be any suitable charging location, for example a depot or any other suitable charging location. There may be more than one charging location. A charging location is provided with one or more chargers 2.

Some embodiments may be used with a mix of different types of electric vehicles 6.

Some embodiments address the technical challenge of ensuring that each electric vehicle 6 of the one or more electric vehicles is charged. Some embodiments may address the technical challenge of ensuring that each electric vehicle 6 of the one or more electric vehicles is charged when required to operate in accordance with a timetable or delivery schedule or operation schedule or the like.

Some embodiments may provide “smart charging” strategies, which may allow the planning and executing of the EV charging operation by exploiting both the system and user flexibility, as a way to cut the peak load and/or recharge vehicles batteries within predefined timetables. Such mechanisms may range from simply turning on and off the charging process and possibly increasing or decreasing the rate of charging, namely unidirectional vehicles' control (V1G), to the challenging bidirectional vehicle-to-grid (V2G), which allows the vehicle to provide back services to the grid in a discharge mode.

In some embodiments, preconditioning of the electric vehicle 6 may be required. This is optional for some embodiments.

Preconditioning an electric vehicle 6, while connected to a power supply, may warm or cool a battery of the electric vehicle to an optimum operating temperature. This may improve the battery life and/or improve the range of the electric vehicle. This may not be required where the electric vehicle is charged before departure such that the battery is still at or close to its usual operating temperature when the electric vehicle is scheduled to depart. This may not be required for some embodiments.

Preconditioning, while connected to a power supply, may alternatively or additionally allow the interior temperature of the electric vehicle 6 to be adjusted to a desired temperature. For example, in winter, a bus may be heated up and in summer the bus may be cooled down. Preconditioning may reduce the amount of battery charge required for controlling temperature in the electric vehicle 6, when the vehicle is not connected to a power supply. Preconditioning may need to be performed shortly before vehicle departure. For example, it may be desirable to ensure that preconditioning is completed as close as possible to the vehicle departure.

Preconditioning may be used in embodiments where the battery of a vehicle is used for a function in addition to driving the vehicle and that function can be provided at least in part in advance before the electric vehicle leaves the charger.

Some embodiments may address the technical challenge of controlling the energy profile required at a charging location to support the one or more chargers 2. The one or more chargers 2 are used to charge the one or more electric vehicles 6.

For example, some embodiments may avoid problems such as an uneven and unpredictable aggregated energy demand profile with high power absorption peaks. An uneven and unpredictable aggregated energy demand profile with high power absorption peaks can lead to bottlenecks in energy supplying capacity. This may reduce the journey capacity of the fleet of vehicles. It may be the case, in some situations, that a high power absorption peak cannot be accommodated and the charging of some batteries could be stopped before the batteries are at the desired level of charge.

Some charging locations may, at least partially, have their own local power supply such as a microgrid. The local power supply may be provided by one or more renewable energy sources, for example a PV (photo voltaic) installation or windfarm, a local energy store, energy store, and/or a local power generator. Some embodiments may manage the use of these resources such that use of one or more of these resources is prioritized over the use of the grid (or vice versa). Some embodiments may manage the charging of electric vehicles (EVs) to match the availability of the renewable resources where possible. Some embodiments may use the local power supply if there is a blackout or an issue on the main power grid.

Some embodiments may manage the peak load of the charging locations. In some embodiments peak load reduction (consumed power) and/or consumed energy (power over time) is considered. Some embodiments may aim to keep the energy load at the charging location below a threshold level. In some embodiments, this threshold level may be less than the maximum peak load which can be supplied. In some embodiments, this threshold is a static threshold. In other embodiments, this threshold may vary.

Some embodiments may aim to ensure that the EVs are ready to be used when required. In the context of a fleet of buses, this may be to ensure that the buses are able to operate according to a required timetable. The electric buses may serve daily driving missions according to prescribed timetables over given routes.

Some embodiments may control the charging processes for one or more electric vehicles. This may be a control for each individual vehicle. Some embodiments may control when the charging process is turned on and/or when the charging process is turned off for each electric vehicle. Some embodiments may control the rate of charging of a particular vehicle, that is to increase or decrease the rate of charging as required. Some embodiments may therefore individually control each charger of the charging location.

In some embodiments, the electric vehicles 6 may only support so-called V1G operations. A V1G operation is where there is unidirectional charging from the electricity grid (and/or other electricity supply) to the electric vehicle 6.

In other embodiments, some or all of the electric vehicles may support so called V2G operations. V2G operations provide bidirectional vehicle-to-grid (V2G) operations. This allows the electric vehicle to be charged from the grid and also allows the vehicle to provide back services to the grid in a discharge mode. Some embodiments may control when a V2G vehicle is charged from a grid and when, if at all, the V2G vehicle discharges back to the grid. The grid may be the main grid and/or a microgrid.

The following examples assume unidirectional V1G operations but it should be appreciated that some embodiments may accommodate V2G vehicles and in particular the discharge back to the grid.

Some embodiments will now be described where the apparatus 4 manages the charging and optional preconditioning which takes place at a charging location. The apparatus 4 may be an apparatus providing at least a part of an EMS (energy management system). The apparatus 4 may be an EMS controller in some embodiments. The apparatus 4 will manage the scheduling of the charging and preconditioning (if provided).

The apparatus 4 may manage so-called slow-charging. However, in other embodiments, so-called fast-charging may alternatively or additionally be managed.

The apparatus 4 may control the chargers 2—when they are charging and/or the rate at which they charge a battery of an EV.

The apparatus 4 may be provided at the charging location and/or may be running at a location remote from the charging location. The apparatus may comprise at least one integrated circuit.

The apparatus 4 of some embodiments is configured to receive information which is used to provide a charging profile, as will be described in more detail later. The information may be provided by one or more of:
input by a user; automatically via an API (application programmable interface); and responsive to an automatic detection of the respective information (for example detecting when an EV is in or at the charging location or on its way to the charging location).

In some embodiments, some of the information may be provided in “real-time”. For example, a current location of an electric vehicle may be provided in real time.

The apparatus 4 may determine a charging profile. This may be based on received or otherwise obtained information.

The apparatus 4 is configured to provide an output in accordance with the determined charging profile. The output provided by the apparatus 4 may be presented on a graphical user interface. The output may comprise one or more control signals which are directly or indirectly provided to the chargers 2. The output from the apparatus 4 is used to control charging by the chargers of electric vehicles.

In some embodiments, an electric vehicle 6 may be automatically charged by a respective charger 2 as a result of the output from the apparatus 4.

The chargers 2 may thus be arranged to receive control signals from the apparatus 4 which controls how each charger charges a respective vehicle. The time when the chargers start charging and stop charging may be controlled by the apparatus 4. The rate at which the charging takes place may be controlled by the apparatus 4.

The chargers 2 may be arranged to provide data to the apparatus 4. That data will be described in more detail later. The data may be provided directly by the chargers 2 to the apparatus 4 or via one or more other entities to the apparatus.

The chargers 2 may be connected to the apparatus 4 via wired and/or wireless connections 8.

The EVs 6 to be charged are plugged into a respective charger 2. Information from the EVs 6 are provided to the apparatus 4. This may be directly and/or via the respective charger. Where the EVs 6 are directly connected to the apparatus 4, this may be via a wired or wireless connection.

The apparatus 4 may be provided with identity information by a respective EV 6 and/or the respective charger 2 indicating which EV is connected to a particular charger.

The identity information associated with the EV can be used by the apparatus to determine information about the battery of that EV. For example, the identity information is used by the apparatus 4 to look up in a database 7 information about the battery. Where a database 7 is provided, this may be a database provided with the apparatus and/or a database which may be accessible via the internet or the like. The database 7 may be part of the apparatus in some embodiments. Alternatively or additionally, the EV 6 may provide at least a part of the information about the battery.

The chargers 2 are connected to the main grid 10 and/or any other suitable electricity supply such as a microgrid or other local power supply (not shown).

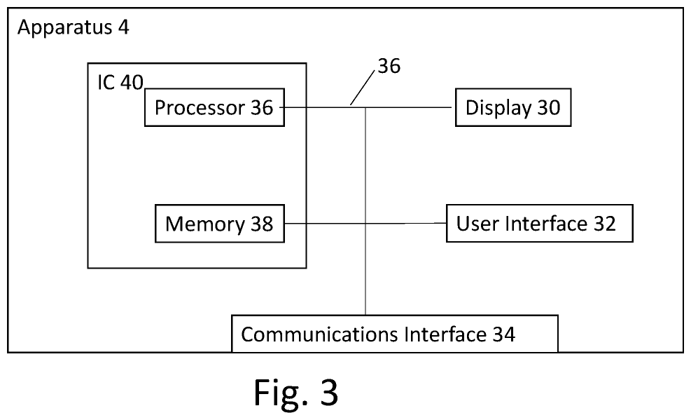

Reference is made to FIG. 3 which shows one example of an apparatus 4 of some embodiments. In this example the apparatus 4 is provided by a computer or a server. It should be appreciated that in other embodiments, the apparatus may comprise two or more servers, two or more computers or a combination of one or more computers and one or more servers. The apparatus may comprise an industrial controller in some embodiments. The apparatus 4 may run a computer program or algorithm.

The apparatus shown in FIG. 3 comprises an integrated circuit (IC) 40. The integrated circuit comprises one or more processors 36 and one or more memories 38. The memory may store computer code defining a computer program or algorithm which may be run on the at least one processor. One or more integrated circuits may be provided, in some embodiments.

A display 30 may be provided to display information to a user. This may be optional in some embodiments. A user interface 32 may be provided in some embodiments. This may be optional in some embodiments. In some embodiments, the user interface 32 may provide the display. This may be the case where the user interface is a touch screen.

The apparatus has a communications interface 34. This allows the apparatus to communicate with the chargers 2, the electric vehicles 6 (where the communication with the EV is not via the charger) and external data sources. The external data sources may provide the apparatus with data from, for example, the power grid supplier and/or availability information, such as timetable information. The communications interface may support wireless and/or wired communications. One or more different communication standards (protocols) may be supported by the communications interface in some embodiments. In some embodiments, there may be a plurality of different communications interfaces.

An internal communications network 36, such as a bus arrangement or the like may be provided in the apparatus to allow communication of data between the integrated circuit 40, the display 30, the user interface 32, and the communications interface 34.

The data which is required by the apparatus 4 from the chargers 2 may be sent directly from the chargers via a communications network to the apparatus 4. The output which is provided by the apparatus 4 to the chargers 2 may be sent directly to the chargers via a communications network.

In some embodiments, the data which is required by the apparatus from the chargers may be sent from the chargers via one or more data hubs (not shown) to the apparatus. The output which is provided by the apparatus to the chargers may be sent to the chargers via one or more data hubs (not shown).

In some embodiments, the apparatus 4 may be provided remote from the charging location, for example, on one or more remote servers. This may optionally be supported by one or more data hubs in the charging location which collect information and send that data to the apparatus 4. Likewise, the control instructions from the apparatus may be distributed by the one or more data hubs to, for example, the chargers 2.

In another embodiment, where the apparatus 4 is located remotely, the communications between the apparatus 4 and the chargers 2 may be via the internet and/or other communications network.

As mentioned, the apparatus 4 of some embodiments, may be provided just by an integrated circuit or two or more integrated circuits.

The apparatus 4 may be configured to determine a charging profile and provide an output to control charging. To achieve this, the apparatus 4 may compute and distribute an active power set-point to every electric vehicle 6 attached to a charger 2 by evaluating future information as well as current information. Alternatively or additionally a reactive power set point can be computed and distributed. In some embodiments, active current and voltage set points and/or reactive current and voltage set points may alternatively or additionally be distributed.

Thus, the current charging profile is determined using information associated with future events. This future information may comprise one or more of: vehicle arrivals; vehicle departures; information associated with the energy supply; foreseen initial battery state of charge; and target state of charge for the battery.

The information associated with the energy supply may be provided by energy availability information or a forecast of a measure of grid load. Energy supply providers may use price to help control energy supply usage and as such this is one way in which grid load measure forecast information may be provided.

The apparatus may use this future information to schedule the charging of the EVs to manage energy usage.

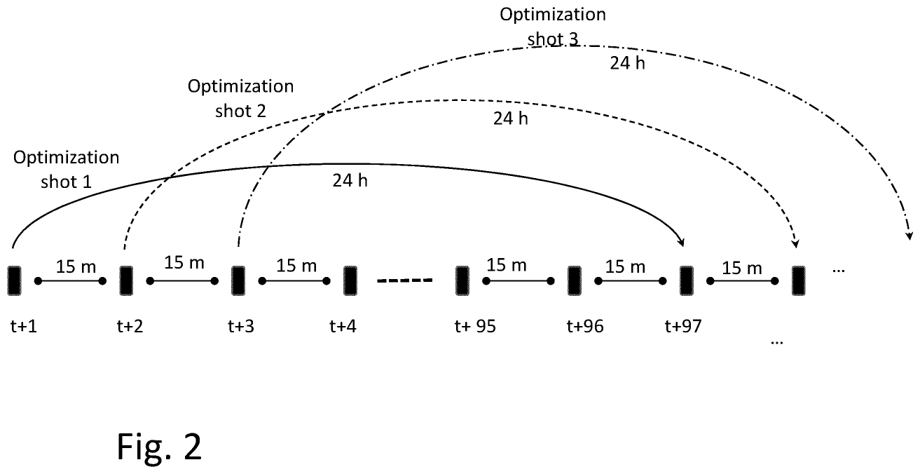

Some embodiments may use a rolling horizon framework to deal with uncertainty associated with future information. For example, there is uncertainty associated with an e-bus battery state of charge (SoC) and an actual arrival time of the e-bus. Accordingly, for a given time interval, a determination is made as to how the charging is to be controlled based on current and future information. For a next time interval, the current information and future information is updated and the determination as to how the charging is to be controlled is re-evaluated or updated. This is shown schematically in FIG. 2. At a current time t+1, data for the next n time slots is taken into account. Each time slot is the same length Δt. In the example shown in FIG. 2 by Δt is 15 minutes. In this example, n=96 so that the time taken into account is 24 hours. However, it should be appreciated that n can be larger or smaller than 96.

Δt can be any suitable value. At may be dependent on the application of the apparatus. For example Δt may be of the order of 15 minutes for a bus depot, as shown in FIG. 2.

At the next current time t+2, the algorithm is re-evaluated for the next n time slots.

In some embodiments, the value of n may be varied. For example, at peak times of operation, n may shorter than during quiet periods of operation or vice versa. It should be appreciated that alternatively or additionally At may vary over time. At may be longer at quieter times and shorter at busier times for example.

The sampling time and/or the optimization horizon (that is how far in the future the determination takes into account) may be set as required. For example, this may be based on data granularity and/or data availability. By way of example only, this may be over a 12 or 24 hour period. Of course, longer or shorter horizons may be used in other embodiments.

The apparatus 4 may collect data from the EVs and the chargers. The data collected comprises one or more of:
Which electric vehicle 6 is attached to a respective charger 2 (for example identity information for the EV);
The state of charge of the battery of the electric vehicle 6; and
The charging/discharging power rate of the battery electric vehicle 6 (this may be alternatively or be obtained from for example a database such as discussed previously).

The apparatus 4 may receive data from a power grid supplier. This may be in response to a request from the apparatus 4. This data may comprise one or more of:
An amount of power the system can provide to the power grid supplier (where supported);
An amount of active power that can be received from the main grid;
A maximum power peak absorption from the main grid;
Grid load information;
Information indicating when there is a greater availability of power; and
Information indicating when there is a lower availability of power.

The apparatus 4 may receive a timetable, operation schedule or other vehicle availability information. This may be from the operator of the charging location. In the example of a bus operator, this information may comprise arrival and departure time data for the buses.

The apparatus 4 may receive data relating to a microgrid and/or local power supply. The apparatus may receive data from one or more microgrid entities and/or may receive data from one or more microgrid controllers. A microgrid may comprise one or more local power sources. The local power source may comprise one or more of: a generator; renewal energy power source; local energy store; wind farm; and a solar panel installation.

The data received from the one or more microgrid entities may be information about energy availability both currently and for the future horizon. A microgrid entity may comprise a meter, a controller, a computer, a monitoring device, or any other suitable entity.

At least one of the chargers 2 may be provided on the microgrid, in some embodiments. Such a charger 2 may additionally be connected to the main grid, in some embodiments.

The apparatus 4 may be provided with information defining one or more of power limits for the charging/discharging of batteries, battery charging/discharging efficiency, and state of charge limitations. This may be obtained from the database 7 or the like which stores this information. In some embodiments, alternatively or additionally this may be provided by the EV 6 itself which stores this information.

The apparatus 4 may control the display 30 to display information. For example, the display 30 may be controlled to display information relating to energy usage. This information may comprise one or more of energy consumption, a value associated with the energy used and/or any other suitable information.

In some embodiments, the apparatus 4 may be configured to display information indicating when each vehicle 6 is to be charged and for how long.

Some embodiments may be implemented on application platforms relying on microservices and containers technology. In some embodiments, the apparatus supports a suite of services. Each service may run separately, for example in its own dedicated container. The services may be relatively small. One or more of the services may be configured to collaborate with one or more of the other services. One or more of the services may be loosely coupled. The use of a microservice platform may provide one or more of the following advantages: flexibility; scalability; maintainability; portability; deployability; testability; and cyber-security.

The apparatus may be configured to provide one or more APIs (application programmable interfaces). One or more of the APIs may be web APIs. One or more of the APIs may be used to publish and/or provide information to and/or from third party systems. For example, the information may comprise timetables, preconditioning data, EV battery SoC information and/or the like. The one or more third party systems may have one or more databases. In some embodiments, the information may be obtained from one or more third party systems and stored in the database 7 used by the apparatus 4.

The apparatus 4 may support one or more different protocols. By way of example only, the apparatus may support Modbus TCP/IP (transmission control protocol/Internet protocol), IEC 60870-104 (an International Electrotechnical Commission standard) used for controlling for example electric power transmission grids or the like and/or the OCCP (open charge point protocol) which supports electric vehicle charging. These protocols are by way of example only and other protocols may alternatively or additionally be used. The apparatus may be configured to support the one or more protocols used by the devices with which the apparatus communicates.

In some embodiments, the data exchanges with external sources and/or for parameter configuration in the system may be via the JSON format and/or using any other suitable data format.

The apparatus 4 may determine a charging profile which schedules charging activities while satisfying equipment physical constraints and/or the needs of the charging location operator. Examples of equipment constraints are charging location capacity and/or charger capacity. Examples of operator's needs may be power peak and/or site efficiency.

Some embodiments provide a computer program which controls the charging location energy management, by determining a charging profile. The computer program may be based on a programming technique using a model. Some embodiments may use a mathematical model. The model may include one or more constraints and/or one or more objectives.

An optimization process can be carried out using the model. However, other embodiments, may use any other suitable programming technique. The computer program may run on the apparatus or any other suitable computing device or devices.

Some embodiments may thus provide an apparatus 4 which determines a charging profile which controls the charging of electric vehicles taking into account both the need for battery recharging and preconditioning.

Some embodiments may thus provide an apparatus 4 which determines a charging profile which controls the timing of the charging, how much charging is done and optionally the rate of charging of the electric vehicles to control the battery recharging. Some embodiments may provide an apparatus 4 which determines a charging profile which controls preconditioning strategies for each electric vehicle.

The apparatus 4 may provide an output which controls the charging by each charger 2 of the EV 6 which is plugged into that charger. The apparatus may provide an output which controls the behaviour of the charger in a given charging time interval. An output may be provided for each charging time interval. This may be updated based on a subsequent iteration for a later rolling horizon.

Alternatively or additionally, the apparatus 4 may provide a full set of charging instructions to a charger 2 which controls how the charger is to charge the EV. This may include when the charging is to start, to end and/or one or more rates which are to be used and when. This may be updated based on a subsequent iteration for a later rolling horizon.

The apparatus 4 may alternatively or additionally send a command to the charger 2 when the charging is to start. This may be with information indicating the charging rate. If the charging rate is to change or stop, the apparatus 4 will send an update command to the charger.

Some embodiments provide an apparatus 4 which is scalable such that the system can be modified to take into account different number of installed electric chargers 2 in different charging locations.

Some embodiments may use a dedicated hard constraint accounting for the maximum number of available chargers 2 for a given charging location.

Some embodiments provide an apparatus 4 which aims to reduce the power peak and/or control the timing of energy usage. This may have an additional benefit of effective energy usage.

Some embodiments provide an apparatus 4 which is able to take into account distributed energy resources or local power sources such as one or more of renewable energy sources, generators, energy storage, PV (photovoltaic) units, (controllable) loads, V2G electric vehicle operations and/or the like.

Some embodiments may use computer programming methods to manage the power consumption operations. The EVs 6 may represent the assets to be modelled by the computer programming methods.

In embodiments of the aspects of the present disclosure, the determining of the charging profile may comprise an optimization process. Possible embodiments of this optimization process are described in the following:

The charging location may be assumed to be connected to the main external grid 10 and consumes (and optionally supplies-in case the charging location is equipped with either renewable energy or conventional generator) power according to the local network power demand.

The electrical distribution infrastructure (e.g., lines, transformers, etc.) may be neglected and the distributed energy resources may be considered to be connected to the utility grid through a single point of connection, namely the point of common coupling (PCC).

In the following, constraints for the PCC, EV and charger (CS) will be described.

In those embodiments using the microservice architecture, data used by the constraints are generated by microservices leveraging on the information stored in the database,

A charging location may have n_{c} chargers. There may be a fleet or set of EVs 6 and the number of vehicles in that fleet or set of EVs may be ne

In the example, the chargers 2 are assumed to be the same. In some embodiments, the apparatus 4 may be controlled to take into account two or more different types of chargers 2. The different chargers may have different charging characteristics for example.

In some embodiments, the charging location connects to the main grid 10 at a PCC. However, in some embodiments there may be more than one PCC.

One constraint PCC1 is the limit on the exchanged active power with main grid 10.

Limitations on power exchange may result from the transformer physical properties.

There may be limitations as a result of agreement restrictions between the main grid and a microgrid MG.

There may be an upper limit on the amount of active power the system can obtain from the power utility supplier. There may alternatively or additionally be a lower or minimum amount of active power which the system has to obtain from the power utility supplier.

Where the system generates power, there may be an upper limit on the amount of power which can be supplied to the grid. There may alternatively or additionally be a requirement that there is a minimum amount of power which has to be supplied to the grid.

There may be a requirement that more power is provided from the grid than is provided to the grid where the system generates power.

If there is a microgrid and the microgrid MG is to be used as the primary power source, the power exchange with the grid may be equal to zero in some situations. However, any shortfall may be made up by the main grid.

In other embodiments, the main grid is used as the primary power source. However, any shortfall may be made up by the microgrid.

In some embodiments, the limit on the exchanged active power with the main grid may be defined by a power capacity.

In some embodiments, there may be no microgrid or the like and all power may be provided by the power supplier.

This information for this constraint relating to the main grid 10 may be provided to the apparatus 4 by the power supplier for the main grid.

There may be a constraint PCC2 which is the maximum peak import power from the main grid 10. This may be regarded as a restriction on the power peak for a time period. This may vary over time or may be a constant value.

This information may be provided by the power supplier for the main grid 10.

PCC1 and/or PCC2 may be considered as examples of available power constraints.

EVs 6 are vehicles that use chemical energy stored in rechargeable batteries to power an electric motor. Where preconditioning is required the energy in the rechargeable batteries are also used to provide the power for this. For example, the batteries may provide power for auxiliary loads such a HVAC (heating, ventilation, and air conditioning) system of some vehicles.

In the following, an EV 6 and more particular the battery of the EVs is modelled using a combination of the following two elements:
1) a battery energy storage
2) a controllable load. This is optional and used where preconditioning is required.

In some embodiments the EVs 6 only support V1G operations. This means that the EV consumes power at the charging location to 1) recharge battery or 2) control temperature through preconditioning (if required), or both. The controlled temperature may be of the battery and/or of the vehicle (e.g. HVAC).

Preconditioning may be modelled by a simple controllable load with a predefined consumption profile. This profile may be defined according to the vehicle timetable and preconditioning requirements. Preconditioning requires certain conditions to be satisfied at a particular time. For example, a temperature of a bus needs to be at a particular value before the bus leaves.

The number of arrivals may equal the number of departures. Logically a vehicle only departs at a time after it arrives.

However, different embodiments may make different assumptions about the number of arrivals compared to the number of departures.

For the energy storage system, constraints on power and energy bounds are considered.

The battery of the EV 6 may have one or more constraints relating to power limits, state of charge and state of charge limitations. It should be appreciated that references to EV 6 charging are of course references to the charging of the one or more batteries of the EV.

EVb1—EV power limits on the charging and/or discharging active power rate of the storage unit (battery) of a given vehicle battery may be provided. There may be a maximum and/or a minimum charging rate. There may be a maximum and/or a minimum discharging rate. This may apply where a battery is discharged to the grid.

EVb2—EV battery dynamics—state of charge (SoC). The state of charge for a next time period may be equal to the current state of charge plus a measure of the charging that has been accomplished in that time period. The measure of the charging that has been accomplished may depend on the power provided, the battery capacity and the storage charging and/or discharging efficiency.

Some embodiments may use information about the number of times a battery has been charged in order to determine its charging and/or discharging characteristics.

EVb3 EV SoC (state of charge) limitations:

These may be predefined limits to avoid extreme SoC levels (full charge/discharge). Those bounds are generally recommended by respective manufacturers. Generally, it is better not to fully discharge a battery to avoid both fast degradation issues and possible permanent damage. The values which are used may change over the lifetime of the battery. There may be a minimum charging level constraint relating to a minimum charging level of battery and/or a maximum charging level constraint relating to a maximum charging level of battery

EV load modelling may be provided where preconditioning is supported.

The load absorption for preconditioning operations may be considered in the total charger power consumption. In this example, EV power absorption for supplying internal loads is modelled as a continuous controllable load. Initial EV demand profiles may be shifted or reshaped in order to reduce the peak demand and/or satisfy the maximum number of available chargers.

EVI1 Controllable load power—this may be represented as a fraction (less than or equal to 1) of the HVAC or other preconditioning load nominal value.

EVI2 Load modulation constraint—this may be based on the load demand being in a range defined by the load demand program forecast of a vehicle at a time plus or minus the nominal power multiplied by a value between 0 and 1. This latter value may be regarded as a measure of its maximum modulation percentage.

EVI3 Load ramp constraint—this represents the maximum ramp rates at which the load power demands of a vehicle can be increased and/or decreased over a given time interval.

EVI4 Load energy constraint—this ensures that the planned energy is supplied within the time between the vehicle 6 arriving and leaving the charging location. The load energy may be shifted or reshaped within the period in which the vehicle 6 is in or at the charging location. For example, the preconditioning can take place some time after the battery has been charged. In some embodiments, the charging profile supporting the preconditioning may be smoothed to avoid peaks and troughs in the load energy. The charging profile can be extended if required.

In determining the charging profile, the apparatus 4 may take into account one or more charger 2 constraints. For example this may be one or more of availability of a charger, numbers of chargers and the charging profile capabilities of the charger.

As previously discussed, the total power consumption of a single EV 6 consists of the sum of battery recharging and preconditioning power where preconditioning is provided. This is the constraint—CS1 for charger total power exchange. In other words there may be a limitation on the charge provided by a given charger.

The second charger CS constraint—CS2. This charger power constraint is the total amount of power absorption of a given vehicle subject to the charger capacity. A vehicle can be either drawing power from the grid or not, when attached to a charger.

The number of EVs which are simultaneously drawing power from the grid at a charging location cannot exceed the number of available chargers providing the third charger constraint CS3—the charger availability constraint.

At each time interval, the total active power demand (for the all the vehicles being charged) has to meet the power supplied by utility grid providing the PB1 Active power balance constraint.

In this example, only unidirectional V1G operation is considered. However in the case of V2G operations, the power supplied may take into account the power supplied by the vehicles.

Some embodiments may use a cost function. The aim of some embodiments is for the apparatus 4 to provide EVs in the charging location with smart charging (and preconditioning strategies where used), without overburdening the grid.

The aim of the apparatus 4 of some embodiments is to control the charging of the EVs battery to its target value while minimizing energy and power usage at times when power availability is lower. For example, in some embodiments, the energy usage at peak demand times is reduced wherever possible. An aim may be to keep a variation in a charging operation of the respective battery within one or more defined limits. An aim may be to minimize a variation in a charging operation of the respective battery of a respective vehicle.

An objective function at time may be considered to be the sum of the following values:
a) a value associated with the usage of power provided by or from the grid. This value may be a measure of the availability of energy. The value may be higher when the available energy is lower. This may be associated with predicted availability and/or current availability.
b) a value associated with the EV. The value associated with the EV may be higher when the battery is not charged within its defined limits or sub optimally.

The value associated with the EV may represent a measure of the penalization for one or more of: the EV SoC's level being different from the target value at departure time: preconditioning rescheduling cost (where provided); and set point fluctuations.

The measure of the penalization of the EV SoC cost may comprise a value associated with an EV in the case of a mismatch between SoC level at the departure time and its desired value.

The measure of the penalization of the EV load set point rescheduling discomfort may quantify the load discomfort caused by rescheduling the precondition power consumption from its initial power program profile.

The measure of the penalization of the EV charging set point fluctuation may be a measure of variations in battery charging operations.

The measure of the penalization of the EV load set point fluctuation may be a measure of variations in preconditioning set point.

In alternative embodiments, the objective function may comprise: the value associated with the usage of power provided by or from the grid: or the value associated with the EV.

Some embodiments may aim to optimally charge each individual battery, where possible. For example, the characteristics of the battery are taken into account when determining the charging profiles. Some embodiments aim to take into account the age and/or the number of times when determining the charging profile. This is because the optimal charging characteristics may change with age and/or number of charging cycles. Some embodiments may alternatively or additionally take into account environmental conditions such as temperature when selecting the charging profile. This may increase the lifetime of the battery and/or provide better battery performance during the lifetime of the battery.

The apparatus 4 may be configured to define optimal charging and preconditioning set points for every EV 6. This may be use power availability information.

Some embodiments may provide an apparatus 4 which is configured to provide an output to control the charging of EVs at the chargers of a charging location. The apparatus is configured to use an optimization process to provide an output. The optimization process aims to provide a solution which satisfies one or more of the constraints and/or one or more objectives. Where there are one or more solutions which satisfy the one or more constraints and/or one or more objectives, the solution associated with a lowest objective function value may be used. This solution may be considered to be an optimal solution. In practice, a so-called optimal solution may or may not be a best solution but may be a solution which meets as far as possible the one or more constraints and/or one or more objectives.

In other embodiments, multiple solutions may be found to the charging and any solution which does not satisfy the required constraints is discarded.

There are a number of different computer programming techniques which may be used in some embodiments. By way of example only, some embodiments, may use a MILP (mixed integer linear program). One approach for solving a MILP is the tree search by a Branch&Bound algorithm with linear programming relaxation. This may have an exponential complexity (NP-hard). In a best case, the complexity of the Branch&Bound algorithm is linear in the number of binary variables bin, i.e. O(bin), and in the worst case a full tree has to be searched, i.e. O(2bin).

The apparatus 4 may use one or more power constraints. These power constraints may be as described previously. There may be a limit on how much power may be purchased and/or on the peak power usage at a given time.

The apparatus 4 may use one or more EV 6 or battery constraints such as described previously. There may be one or more constraints relating to power limits, state of charge and state of charge limitations.

The apparatus 4 may use one or more load constraints associated with preconditioning (where provided) such as described previously. There may be one or more constraints relating to when the preconditioning is to take place, the maximum ramp rates at which the power demands can be increased/decreased, and the preconditioning demand power.

The apparatus 4 may use one or more charger constraints such as described previously. There may be one or more constraints relating the number of chargers, a total power consumption of an EV and charger capacity.

The apparatus 4 may use the active power balance constraint. In other words, the power used in a given time period cannot exceed the total available power. This power may come from the main grid 10 and/or from a local power source.

The apparatus 4 may use information about the whether a vehicle 6 is available for charging or not as an availability constraint. The availability of an EV 6 may be provided by one or more of an operation schedule, location information of the EV 6 and real time location of the EV 6. The operation schedule may be a timetable or the like. The location information may be a real time location of the EV 6 such as a GPS location of the EV 6 or may be a predicted location of the EV 6. This predicted location may be based on a previous location of the EV and may take into account time lapsed and/or traffic information.

The apparatus 4 may use information relating to the SoC for an EV 6 when it arrives. This may be the actual SoC for an arrived vehicle or a predicted SoC if the vehicle is yet to arrive but is due to arrive within the considered horizon.

Various examples of constraints and objectives have been described. One or more of these constraints and/or objectives may be omitted from the determination of the charging profile.

The constraints which are used may depend on what information is available and/or on limitations in the availability of energy resources. For example, where there are a number of different consumers (which may be at different charging locations or other energy users) sharing a common energy resource, it may be desirable to optimize as far as possible the usage of the energy resource at a charging location. This may be achieved by using a larger number of the different constraints.

Alternatively or additionally, the constraints may depend on the relative importance of that constraint for the particular application. For example, an EV availability constraint may be less important for a fleet of delivery vehicles as compared to a fleet of busses

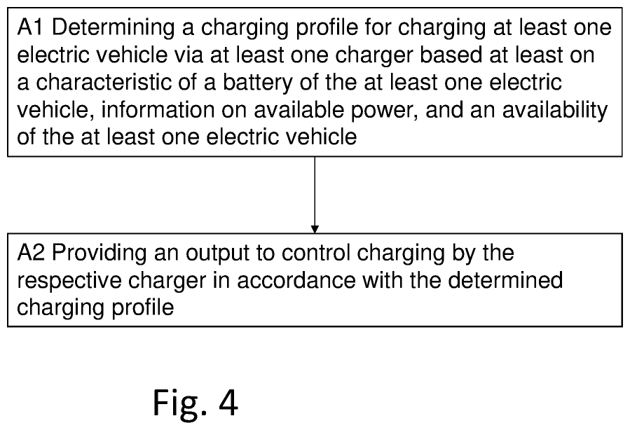

Reference is made to FIG. 4 which shows a method of some embodiments.

In A1, the method comprises determining a charging profile for charging at least one electric vehicle via at least one charger based at least on a characteristic of a respective battery of the at least one electric vehicle, information on available power and an availability of the at least one electric vehicle.

Any one or more of the examples of characteristics of the battery previously discussed may be used.

Any one or more of the examples of availability of the at least one electric vehicle previously discussed may be used

Any one or more of the examples of information on available power previously discussed may be used

In A2, the method comprises providing an output to control charging by the respective one of the chargers in accordance with the determined charging profile.

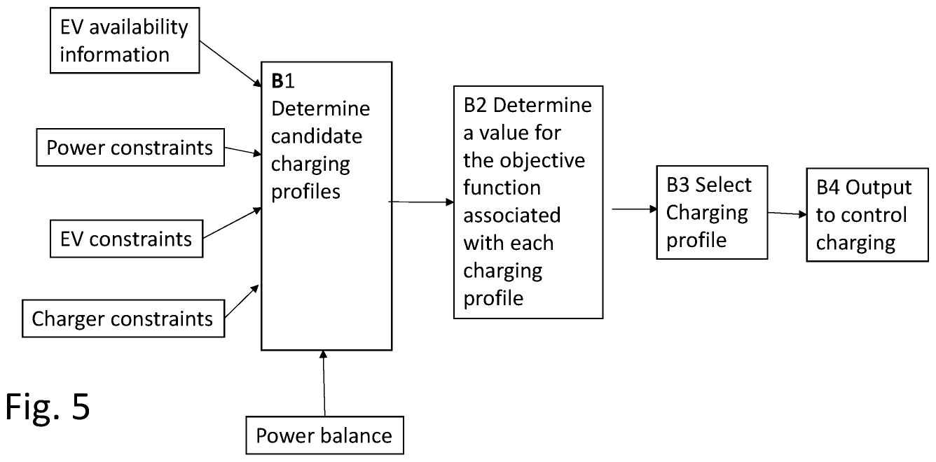

Reference is made to FIG. 5 which schematically shows a more detailed method of some embodiments.

In B1, the method comprises determining candidate charging profiles for charging at least one electric vehicle via at least one charger based at least on a characteristic of a battery of the at least one electric vehicle, information on available power and an availability of the at least one electric vehicle.

The candidate charging profiles may define when respective electric vehicle are to be charged and optionally, the rate at which each EV is to be charged.

The determining takes into account EV scheduling information or other availability information. This scheduling information provides information as to when EVs are to arrive and when they are to depart. This may be for specific vehicles or may only be that an EV has to be ready to depart at a particular time but it can be any of the EVs.

The determining of the candidate charging profiles takes into account one or more constraints. In the method shown in FIG. 5, the constraints are one or more power constraints, one or more EV constraints and one or charger constraints. These constraints may be any one or more of the previously described constraints. One or more of these constraints may be omitted.

The determining also takes into account the power balance requirement.

It may not be possible to determine a solution which satisfies all the constraints. In that scenario, one or more constraints may be prioritized over others. For example the power balance requirement may be prioritized.

Some constraints are hard constraints, such as the number of chargers.

Where the maximum peak input power is one of the constraints, an exceeding of this constraint for a relatively short period of time and by no more than a threshold amount may be tolerated.

Where preconditioning is provided, the one or more associated constraints may at least be partially ignored if a charging profile where that constraint is satisfied (as well as other constraints) cannot be found.

The priority of the EV availability information may be dependent on the nature of the respective charging location. For example, for a bus depot, the requirement to have a bus ready to depart at a particular time may be given priority over other constraints. However, in other scenarios, the EV availability information may be given a lower priority as compared to other constraints.

In B2, a value is determined for the objective function associated with each candidate charging profile. This may be the objective function discussed previously.

In B3, one or more of the charging profiles are selected in dependence on the value of the objective function. A selected charging profile may be associated with the smallest value of the associated objective function.

In B4, an output to control the charging of an EV by the respective charger based on the selected charging profile is provided.

It should be appreciated that the method of FIG. 5 may be repeated for a next time horizon. Some embodiments may repeat the method of FIG. 5 in its entirety for the next time horizon. Other embodiments may determine if the solution provided for the previous time horizon can still be used while still satisfying the required constraints. If so, the charging profile determined in the previous iteration of the method is continued to be used. In some embodiments, the previously determined charging profile is only continued to be used if one or more values remain within defined thresholds.

It should be appreciated that B1 to B3 of FIG. 5 provide one example in which the method of A1 of FIG. 4 may be carried out. In other embodiments, any other suitable optimization process may be performed to determine the charging profile to be used.

The apparatus may take into account the scenario where the EV discharges power into the system. In this embodiment, the battery discharge behaviour may be taken into account.

Some embodiments may take into account additional power sources such previously described as well the bi-directional V2G operations which allow the vehicle to provide back services to the grid in a discharge mode.

In the preceding examples, it has been assumed that an electric vehicle is only charged at its base or charging location. It should be appreciated, that in other embodiments, one or more vehicles may be charged at one or more points on route. This may be taken into account when determining the level to which the battery is to be charged when the electric vehicle is charged at the charging location.

In the preceding examples, it has been assumed that the charging location provides slow charging of vehicles. In other embodiments, partial or exclusive fast charging may be supported.

Some embodiments have been described as being implemented on application platforms relying on microservices and containers technology. This is by way of example only and other embodiments may be implemented using any other suitable computer programming technique.

In at least one embodiment the method may be a computer implemented method. The method may be executed by one or more integrated circuits. Furthermore, the method may be implemented on a computing device or may be implemented on an industrial controller.

The embodiments may thus vary within the scope of the attached claims. In general, some embodiments may be implemented in hardware or special purpose circuits, software, logic, or any combination thereof. For example, some aspects may be implemented in hardware, while other aspects may be implemented in firmware or software which may be executed by a controller, microprocessor, or other computing device, although embodiments are not limited thereto.

Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more embodiments with any of the other embodiments previously discussed.

1. A method for controlling the charging of at least one electric vehicle via at least one charger, the method comprising:
determining a charging profile for charging the at least one electric vehicle via the at least one charger based at least on a characteristic of a battery of the at least one electric vehicle, information on available power, and an availability of the at least one electric vehicle; and
providing an output to control charging by the at least one charger in accordance with the determined charging profile.

2. The method of claim 1, wherein the availability of the at least one electric vehicle is based at least on one of an operation schedule, location information of the at least one electric vehicle, or real time location information of the at least one electric vehicle

3. The method of claim 1, wherein the determining of the charging profile for charging the at least one electric vehicle is further based on a requirement of preconditioning of the at least one electric vehicle.

4. The method of claim 3, further comprising providing an output to control the preconditioning of the at least one electric vehicle.

5. The method of claim 1, wherein the information on available power comprises information about power suppliable by one or more of a power grid or one or more local power sources.

6. The method of claim 1, wherein the determining of the charging profile for charging the at least one electric vehicle comprises an optimization process.

7. The method of claim 6, wherein the optimization process comprises a first objective to reduce variations in charging operations and/or preconditioning operations provided by the charging profile.

8. The method of claim 6, wherein the optimization process comprises a minimum charging level constraint relating to a minimum charging level of the respective battery of the at least one electric vehicle.

9. The method of claim 8, wherein the optimization process comprises a second objective to maximize a charging level of the respective battery beyond the minimum charging level, in particular up to a predefined charging level.

10. The method of claim 6, wherein the optimization process comprises an available power constraint relating to the information on the available power.

11. The method of claim 6, wherein the optimization process comprises an electric vehicle availability constraint relating to the availability of the at least one electric vehicle.

12. The method of claim 6, wherein the optimization process comprises a battery maximum load constraint relating to a maximum load applicable to the respective-battery.

13. The method of claim 1, wherein the determining is further based on a power supply limit associated with one or more of the at least one charger.

14. The method of claim 1, wherein the characteristic of the battery comprises a charging state of the battery.

15. The method of claim 1, wherein the characteristic of the battery comprises at least one of:
one or more charging state limitations; or
one or more charging rate limitations.

16. The method of claim 1, wherein the determining of the charging profile for charging the at least one electric vehicle is further based on information relating to a current time period and information from one or more future time periods.

17. The method of claim 1, wherein the determining of the charging profile for charging the at least one electric vehicle is repeated at a subsequent time to update the charging profile.

18. The method of claim 1, wherein the output to control charging controls one or more of when the at least one electric vehicle is charged and a rate at which the at least one electric vehicle is charged.

19. A non-transitory computer-readable medium having a computer program stored thereon, the computer program comprising computer executable code which, when run on at least one processor, is configured to perform the method of claim 1.

20. An apparatus configured to control the charging of one or more electric vehicles via one or more chargers, the apparatus comprising at least one integrated circuit configured to cause the apparatus to execute the method of claim 1.
